(19) United States
(12) Patent Application Publication
(10) Pub. No.: US 2021/0199919 A1
(43) Pub. Date: Jul. 1, 2021

(54) CONTROL DEVICE, PHOTOGRAPHING DEVICE, CONTROL METHOD, AND PROGRAM

(71) Applicant: VICTOR HASSELBLAD AB, Götenborg (SE)

(72) Inventors: Longji BAI, Shenzhen (CN); Takashi KOYAMA, Shenzhen (CN); Yongwang XU, Shenzhen (CN)

(21) Appl. No.: 17/179,326

(22) Filed: Feb. 18, 2021

Related U.S. Application Data
(63) Continuation of application No. PCT/CN2019/101724, filed on Aug. 21, 2019.

(30) Foreign Application Priority Data
Aug. 28, 2018 (JP) 2018-159263

(51) Int. Cl. G02B 7/36; G02B 7/09; G03B 13/36

(52) U.S. Cl. CPC G02B 7/36; G02B 7/08; G03B 13/36; G02B 7/09

(57) ABSTRACT

A control device includes a processor and a storage device storing instructions that, when executed by the processor, cause the processor to determine a first rotation amount of a motor, configured to control a lens, from a time when the motor starts rotating to a time when a speed of the lens reaches a predetermined speed, in response to the speed of the lens reaching the predetermined speed, determine a second rotation amount of the motor from a time when the motor is instructed to stop rotating to a time when the lens stops, and control the motor so that the lens moves to a target position when the lens moves to a reference position with a distance to the target position of the lens greater than a distance corresponding to a third rotation amount, which is a sum of the first rotation amount and the second rotation amount.

### CROSS-REFERENCE TO RELATED APPLICATIONS

This application is a continuation of International Application No. PCT/CN2019/101724, filed Aug. 21, 2019, which claims priority to Japanese Application No. 2018-159263, filed Aug. 28, 2018, the entire contents of both of which are incorporated herein by reference.

### TECHNICAL FIELD

The present disclosure relates to a control device, a photographing device, a control method, and a program.

### BACKGROUND

Patent Document 1 discloses that when a contrast detection autofocus method is used, at a start time point of a search, a motor is operated at a certain drive speed, and the motor is stopped to drive before a lens reaches a target position.

Patent Document 1: Japanese Publication No. 2017-138414.

Because of influences from characteristics of the lens, a state of the lens, or a surrounding environment of the lens, etc., it may be difficult to stop the lens accurately at the target position.

### SUMMARY

In accordance with the disclosure, there is provided a control device comprising a processor and a storage device storing instructions that, when executed by the processor, cause the processor to determine a first rotation amount of a motor, configured to control a lens, from a time when the motor starts rotating to a time when a speed of the lens reaches a predetermined speed, in response to the speed of the lens reaching the predetermined speed, determine a second rotation amount of the motor from a time when the motor is instructed to stop rotating to a time when the lens stops, and in response to the lens moving to a reference position with a distance to a target position of the lens greater than a distance corresponding to a third rotation amount, control the motor so that the lens moves to the target position, where the third rotation amount is a sum of the first rotation amount and the second rotation amount.

Also in accordance with the disclosure, there is provided a photographing device including the control device and the lens.

Also in accordance with the disclosure, there is provided a movable object comprising a photographing device and a support mechanism supporting the photographing device and configured to change an attitude of the photographing device. The photographing device includes a lens, a motor configured to drive the lens, and a control device including a processor, and a storage device storing instructions that, when executed by the processor, cause the processor to determine a first rotation amount of the motor from a time when the motor starts rotating to a time when a speed of the lens reaches a predetermined speed, in response to the speed of the lens reaching the predetermined speed, determine a second rotation amount of the motor from a time when the motor is instructed to stop rotating to a time when the lens stops, and in response to the lens moving to a reference position with a distance to a target position of the lens greater than a distance corresponding to a third rotation amount, control the motor so that the lens moves to the target position, where the third rotation amount is a sum of the first rotation amount and the second rotation amount.

Also in accordance with the disclosure, there is provided a control method comprising determining a first rotation amount of a motor, configured to control a lens, from a time when the motor starts rotating to a time when a speed of the lens reaches a predetermined speed, in response to the speed of the lens reaching the predetermined speed, determining a second rotation amount of the motor from a time when the motor is instructed to stop rotating to a time when the lens stops, and in response to the lens moving to a reference position with a distance to a target position of the lens greater than a distance corresponding to a third rotation amount, controlling the motor so that the lens moves to the target position, where the third rotation amount being a sum of the first rotation amount and the second rotation amount.

Also in accordance with the disclosure, there is provided a non-transitory computer-readable storage medium storing a program that, when executed by a computer, causes the computer to perform the control method.

### BRIEF DESCRIPTION OF THE DRAWINGS

FIG. 1 is a schematic perspective view of a photographing device according to an embodiment of the disclosure.

FIG. 2 is a diagram showing functional blocks of a photographing device according to an embodiment of the disclosure.

FIG. 3 is a diagram for explaining actions of a focus lens when a contrast detection autofocus (AF) is performed.

FIG. 4 is a flowchart of a process of performing a contrast detection AF according to an embodiment of the disclosure.

FIG. 5 is a schematic diagram showing an unmanned aerial vehicle (UAV) and a remote operation device.

FIG. 6 is a diagram of a hardware configuration according to an embodiment of the disclosure.

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

Various embodiments of the present disclosure are described with reference to flowcharts and block diagrams. A block may represent a stage of a process of performing operations or a “unit” of a device that performs operations. The specific stages and “units” can be implemented by programmable circuits and/or processors. A “unit” can also include a hardware assembly. A dedicated circuit may include a digital and/or an analog circuit, or may include an integrated circuit (IC) and/or a discrete circuit. A programmable circuit may include a reconfigurable circuit. The reconfigurable circuit may include a circuit with a logic operation such as logic AND, logic OR, logic XOR, logic NAND, logic NOR, or another logic operation, a flip-flop, a register, a field programmable gate array (FPGA), a programmable logic array (PLA)), or another memory component.

The computer-readable medium may include any tangible device that can store instructions to be executed by a suitable device. As a result, the computer-readable medium with instructions stored is provided with a product including instructions that can be executed to create means for performing operations specified by the flowchart or the block diagram. The computer-readable medium may include electronic storage media, magnetic storage media, optical storage media, electromagnetic storage media, semiconductor storage media, or the like. As a more specific example of the computer-readable medium, it may include a Floppy® disk, a soft disk, a hard disk, a random-access memory (RAM), a read-only memory (ROM), an erasable programmable read-only memory (EPROM or a flash memory), an electrically erasable programmable read-only memory (EEPROM), a static random access memory (SRAM), a compact disc read-only memory (CD-ROM), a digital versatile disc (DVD), a Blu-ray® disc, a memory stick, or an integrated circuit card, etc.

The computer-readable instructions may include any one of source code or object code described in any combination of one or more programming languages. The source code or object code can include a programming language such as assembly instructions, instruction set architecture (ISA) instructions, machine instructions, machine-related instructions, microcode, firmware instructions, status setting data, or object-oriented programming languages such as Smalltalk, JAVA (registered trademark), C++, etc., or “C” programming language or similar programming languages. The computer-readable instructions may be provided locally or via a wide area network (WAN) such as a local area network (LAN) or an internet to a processor or a programmable circuit of a general-purpose computer, a special-purpose computer, or other programmable data processing device. The processor or programmable circuit can execute computer-readable instructions to create means for performing the operations specified in the flowchart or block diagram. Examples of processors include computer processors, processing units, microprocessors, digital signal processors, controllers, microcontrollers, and so on.

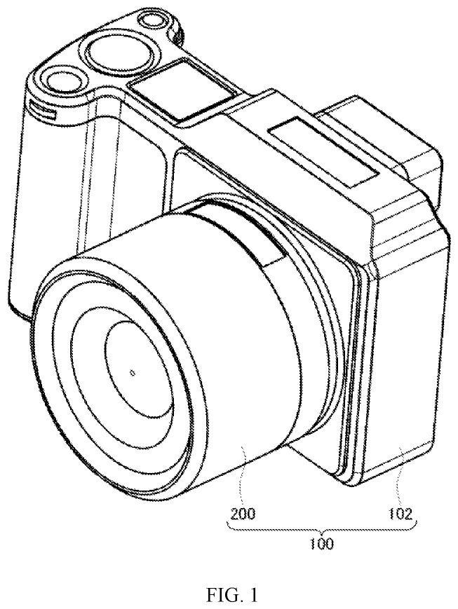

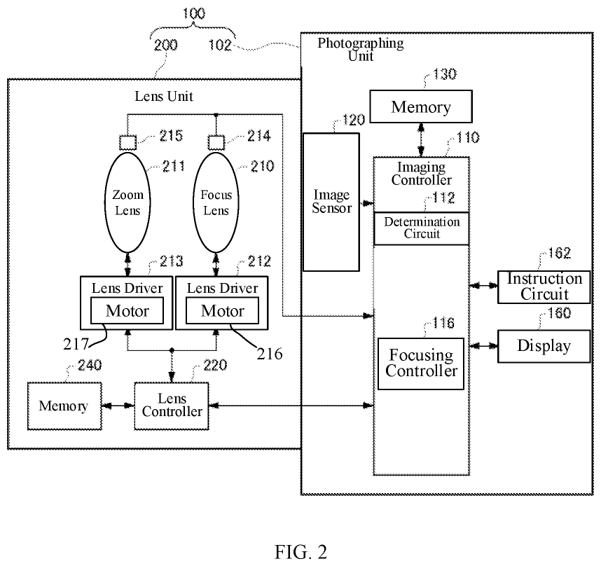

FIG. 1 is a schematic perspective view of a photographing device 100 according to an embodiment of the disclosure. FIG. 2 is a diagram showing functional blocks of the photographing device 100 according to an embodiment of the disclosure.

The photographing device 100 includes a photographing unit 102 and a lens unit 200. The photographing unit 102 includes an image sensor 120, an imaging controller 110, and a memory 130. The image sensor 120 may include charge-coupled device (CCD) sensor or complementary metal-oxide-semiconductor (CMOS) sensor. The image sensor 120 captures optical images formed through a zoom lens 211 or a focus lens 210, and outputs the captured images to the imaging controller 110. The imaging controller 110 may include a microprocessor such as a central processing unit (CPU) or a micro processing unit (MPU), a microcontroller such as a micro controlling unit (MCU), or the like. The memory 130 may be a computer-readable recording medium, and may include at least one of an SRAM, a DRAM, an EPROM, an EEPROM, or a flash memory such as a USB memory. The memory 130 stores programs that the imaging controller 110 uses to control the image sensor 120 and the like. The memory 130 may be provided inside a housing of the photographing device 100. The memory 130 may be configured to be detachable from the housing of the photographing device 100.

The photographing unit 102 further includes an instruction circuit 162 and a display 160. The instruction circuit 162 can include a user interface that accepts instructions to the photographing device 100 from the user. The display 160 can display images captured by the image sensor 120, various setting information of the photographing device 100, and/or the like. The display 160 may include a touch panel.

The lens unit 200 includes a focus lens 210, a zoom lens 211, a lens driver 212, a lens driver 213, and a lens controller 220. The focus lens 210 and the zoom lens 211 may include at least one lens. At least a part of or the entire focus lens 210 and zoom lens 211 are configured to be movable along an optical axis. The lens unit 200 may be an interchangeable lens that is provided to be detachable from the photographing unit 102. The lens driver 212 includes a motor 216. The motor 216 may be a direct-current (DC) motor, a coreless motor, or an ultrasonic motor. The lens driver 212 transmits the power from the motor 216 to at least a part of or the entire focus lens 210 through a mechanism member such as a cam ring or a guide shaft, and moves at least a part of or the entire focus lens 210 along the optical axis. The lens driver 213 includes a motor 217. The motor 217 may be a step motor, a DC motor, a coreless motor, or an ultrasonic motor. The lens driver 213 transmits the power from the motor 217 to at least a part of or the entire zoom lens 211 through a mechanism member such as a cam ring or a guide shaft, and moves at least a part of or the entire zoom lens 211 along the optical axis. The lens controller 220 drives at least one of the lens driver 212 or the lens driver 213 according to a lens control command from the photographing unit 102, and moves at least one of the focus lens 210 or the zoom lens 211 along the optical axis through a mechanism member in order to perform at least one of a zoom action or a focus action. The lens control command may be a zoom control command or a focus control command.

The lens unit 200 further includes a memory 240, a position sensor 214, and a position sensor 215. The memory 240 stores control values of the focus lens 210 and the zoom lens 211 that are moved by the lens driver 212 and the lens driver 213. The memory 240 may include at least one of an SRAM, a DRAM, an EPROM, an EEPROM, or a flash memory such as a USB memory. The position sensor 214 detects a position of the focus lens 210. The position sensor 214 can detect a current focus position. The position sensor 215 detects a position of the zoom lens 211. The position sensor 215 can detect a current zoom position of the zoom lens 211. The position sensor 214 and the position sensor 215 may be magneto resistive (MR) sensors.

In the photographing device 100 as described above, for example, in order to drive a large and heavy focus lens 210, the motor 216 may use a DC motor. When a step motor is used, a rotation of the step motor can be stopped immediately when the step motor reaches a target rotation amount (number of pulses). However, even if a current supply is stopped, the DC motor may not immediately stop rotating. Therefore, first, a current is supplied to the DC motor to cause a speed of the focus lens 210 to reach a predetermined speed. Then, at a time when a rotation amount of the DC motor during a time period from a time when the current supplied to the DC motor is stopped until a time when the DC motor stops rotating (until the focus lens 210 is stopped) is considered, the current supplied to the DC motor is stopped to stop the focus lens 210 at a target position.

However, a rotation amount of the DC motor until the speed of the focus lens 210 reaches the predetermined speed or a rotation amount of the DC motor until the DC motor stops rotating differs depending on characteristics of the lens unit 200. These rotation amounts also differ depending on attitude of the lens unit 200 and the like. For example, these rotation amounts differ depending on whether the lens unit 200 faces upward or downward. These rotation amounts also differ depending on surrounding environments in which the photographing device 100 exists. When the surrounding environment in which the photographing device 100 exists changes, a friction force for stopping the focus lens 210 may change. Therefore, when a DC motor is used as the motor 216 for driving the focus lens 210, it is not easy to accurately stop the focus lens 210 at the target position in a short time, which also happens when a coreless motor or an ultrasonic motor is used.

Therefore, when the focus lens 210 is driven, the photographing device 100 consistent with the disclosure determines the rotation amount of the motor 216 until the speed of the focus lens 210 reaches the predetermined speed and the rotation amount of the motor 216 until the motor 216 stops rotating. Then, the photographing device 100 controls the motor 216 according to these rotation amounts to stop the focus lens 210 at the target position.

For example, when a contrast detection autofocus (AF) is performed, the photographing device 100 determines the rotation amount of the motor 216 until the speed of the focus lens 210 reaches the predetermined speed. Further, when the focus lens 210 is stopped according to a detection of a peak value of a contrast evaluation value, the photographing device 100 determines the rotation amount of the motor 216 until the motor 216 stops rotating. According to these rotation amounts, the photographing device 100 moves the focus lens 210 to a target position corresponding to the peak value of the contrast evaluation value.

The imaging controller 110 includes a determination circuit 112 and a focusing controller 116. The determination circuit 112 determines a rotation amount R1 of the motor 216 from a time when the motor 216 starts to rotate to a time when the speed of the focus lens 210 reaches the predetermined speed. The determination circuit 112 may determine the rotation amount R1 of the motor 216 according to a detection result detected by the position sensor 214. A drive mechanism that transmits the power from the motor 216 to the focus lens 210 includes a gear mechanism. Therefore, before the focus lens 210 starts to move, the motor 216 idles due to a gear backlash. Therefore, the rotation amount R1 includes a predetermined rotation amount Rb for a period while the motor 216 rotates but the focus lens 210 does not move because of the gear backlash of the gear mechanism.

The determination circuit 112 may determine the rotation amount R1 of the motor 216 according to a distance moved by the focus lens 210 from the time when the motor 216 starts to rotate to the time when the speed of the focus lens 210 reaches the predetermined speed, and the rotation amount Rb due to the gear backlash.

In a state where the speed of the focus lens 210 is the predetermined speed, the determination circuit 112 determines a rotation amount R2 of the motor 216 from a time when the motor 216 is instructed to stop rotating to a time when the focus lens 210 is stopped. In the state where the speed of the focus lens 210 is the predetermined speed, the determination circuit 112 may determine a rotation amount from a time when the motor 216 is instructed to stop rotating and the current is stopped to supply to the motor 216 to a time when the motor 216 stops rotating as the rotation amount R2.

After the focus lens 210 moves to a position (also referred to as a “reference position”) with a distance to the target position of the focus lens 210 greater than a distance H corresponding to a rotation amount R3, the focusing controller 116 controls the motor 216 to move the focus lens 210 to the target position. R3 is a sum of the rotation amount R1 and the rotation amount R2. The rotation amount R1 is an example of a first rotation amount. The rotation amount R2 is an example of a second rotation amount. The rotation amount R3 is an example of a third rotation amount.

After causing the focus lens 210 to move to a position with a distance to the target position of the focus lens 210 greater than the distance H corresponding to the rotation amount R3 and stop, the focusing controller 116 controls the motor 216 to start rotating. Further, in the state where the speed of the focus lens 210 is the predetermined speed, the focusing controller 116 may instruct the motor 216 to stop rotating when the rotation amount of the motor 216 needed for the focus lens 210 to reach the target position reaches a remaining rotation amount R2.

The determination circuit 112 can determine a first rotation amount of the motor 216 from a time when the motor 216 starts to rotate in a first rotation direction to a time when the speed of the focus lens 210 reaches the predetermined speed. Further, in the state where the speed of the focus lens 210 is the predetermined speed, the determination circuit 112 may determine the rotation amount R2 of the motor 216 from a time when the motor 216 is instructed to stop rotating in the first rotation direction to a time when the focusing lens 210 is stopped.

The focusing controller 116 can move the focus lens 210 to a position with a distance to the target position of the focus lens 210 greater than the distance H corresponding to the rotation amount R3 by rotating the motor 216 in a second rotation direction opposite to the first rotation direction. Then, the focusing controller 116 may control the motor 216 to start rotating in the first rotation direction, and in the state where the speed of the focus lens 210 is the predetermined speed, instruct the motor 216 to stop rotating in the first rotation direction when the rotation amount of the motor 216 needed for the focus lens 210 to reach the target position reaches the remaining rotation amount R2.

When the contrast detection AF is started, the determination circuit 112 may determine the rotation amount R1 of the motor 216 from a time when the motor 216 starts rotating in the first rotation direction to a time when the speed of the focus lens 210 reaches the predetermined speed. Further, in the state where the speed of the focus lens 210 is the predetermined speed and during a process of performing the contrast detection AF, the determination circuit 112 may determine the rotation amount R2 from a time when the motor 216 is instructed to stop rotating in the first rotation direction according to the detection of the peak value of the contrast evaluation value to a time when the focus lens 210 is stopped.

After the focus lens 210 stops corresponding to the detection of the peak value of the contrast evaluation value, the focusing controller 116 moves the focus lens 210 from the target position corresponding to the position of the focus lens 210 when the peak value of the contrast evaluation value is detected to a position with a distance to the target position of the focus lens 210 greater than the distance H corresponding to the rotation amount R3 by rotating the motor 216 in the second rotation direction opposite to the first rotation direction. Then, the focusing controller 116 controls the motor 216 to start rotating in the first rotation direction, and in the state where the speed of the focus lens 210 is the predetermined speed, instructs the motor 216 to stop rotating in the first rotation direction when the rotation amount of the motor 216 needed for the focus lens 210 to reach the target position reaches the remaining rotation amount R2.

As described above, when the focus lens 210 is driven, the determination circuit 112 determines the rotation amount of the motor 216 until the speed of the focus lens 210 reaches the predetermined speed and the rotation amount of the motor 216 until the motor 216 stops rotating. The focusing controller 116 controls the motor 216 according to these rotation amounts to stop the focus lens 210 at the target position. Even if the rotation amount R1 and the rotation amount R2 change because of a change in the attitude of the lens unit 200, or the surrounding environment in which the photographing device 100 exists, the focus lens 210 can be accurately stopped at the target position in a short time.

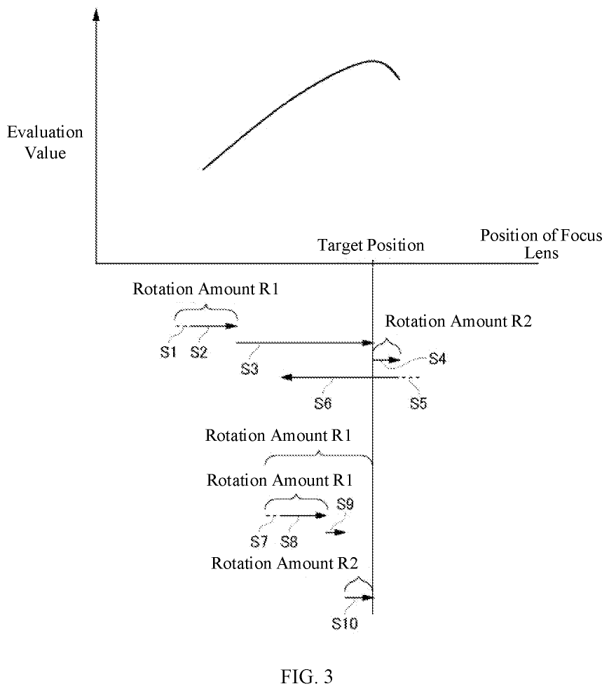

FIG. 3 is a diagram for explaining actions of the focus lens 210 when a contrast detection AF is performed.

In order to perform the contrast detection AF, the focusing controller 116 controls the motor 216 to rotate in a first rotation direction. Before the focus lens 210 starts to move, the motor 216 idles due to a gear backlash (S1). When the focus lens 210 starts to move, the focusing controller 116 controls the motor 216 so that a speed of the focus lens 210 reaches a predetermined speed (S2). The determination circuit 112 determines a rotation amount R1 of the motor 216 until a time when the speed of the focus lens 210 reaches the predetermined speed taking into consideration idling caused by the gear backlash.

While the motor 216 is driven to move the focus lens 210, the focusing controller 116 derives a contrast evaluation value of an image captured by the photographing device 100 (S3). When a peak value of the contrast evaluation value is detected, the focusing controller 116 determines a position of the focus lens 210 with the peak value detected as a target position. Further, corresponding to a detection of the peak value of the evaluation value, the focusing controller 116 instructs the lens controller 220 to stop the motor 216. Thus, a supply of current to the motor 216 is stopped. After receiving a stop instruction, the motor 216 rotates until the focus lens 210 stops due to a friction force (S4). The determination circuit 112 determines a rotation amount R2 of the motor 216 from a time when the lens controller 220 is instructed to stop the motor 216 to a time when the motor 216 stops rotating.

Then, in order to move the focus lens 210 to a position with a distance to the target position of the focus lens 210 greater than a distance H corresponding to a rotation amount R3, the focusing controller 116 controls the motor 216 to rotate in a second rotation direction. The rotation amount R3 is a sum of the rotation amount R1 and the rotation amount R2. The motor 216 idles due to a gear backlash (S5), and then further rotates and stops (S6). The focus lens 210 stops once it exceeds the target position.

The focusing controller 116 determines a rotation amount Rt of the motor 216 needed for the focus lens 210 to move from a stop position to the target position. The focusing controller 116 determines the rotation amount Rt according to a position where the focus lens 210 stops, the target position, the rotation amount R1, and the rotation amount R2.

In order to control the motor 216 to rotate in the first rotation direction again and stop the focus lens 210 at the target position, the focusing controller 116 instructs the lens controller 220 to supply current to the motor 216. The focusing controller 116 controls the motor 216 through the lens controller 220 so that the speed of the focus lens 210 reaches the predetermined speed. Therefore, the motor 216 rotates after idling (S7) until the speed of the focus lens 210 reaches the predetermined speed (S8).

Further, the focusing controller 116 continues instructing to supply current to the motor 216 until a rotation amount of the motor 216 needed for the focus lens 210 to reach the target position reaches the remaining rotation amount R2 (S9). Then, the focusing controller 116 instructs the lens controller 220 to stop the motor 216 to rotate in the first rotation direction when the rotation amount of the motor 216 reaches the remaining rotation amount R2. Therefore, after the motor 216 is rotated by the rotation amount R2, the focus lens 210 stops at the target position due to the friction force (S10).

In order to perform the contrast detection AF, the determination circuit 112 determines the rotation amount R1 and the rotation amount R2 when the motor 216 is rotated in the first rotation direction and stopped. Before the focus lens 210 moves to the target position, the focusing controller 116 controls the motor 216 to rotate in the second rotation direction to move the focus lens 210 until the motor 216 rotates in the first rotation direction by the rotation amount R3 or more and stops. The rotation amount R3 is the sum of the rotation amount R1 and the rotation amount R2. Then, the focusing controller 116 controls the motor 216 to rotate in the first rotation direction again and stop, so that the focus lens 210 stops at the target position. The determination circuit 112 determines the rotation amount R1 and the rotation amount R2, and the focusing controller 116 controls the motor 216 according to the rotation amount R1 and the rotation amount R2. Therefore, even if the friction force acting on the focus lens 210 changes because of a change in an attitude of the lens unit 200, or a surrounding environment in which the photographing device 100 exists, the focus lens 210 can be accurately stopped at the target position in a short time.

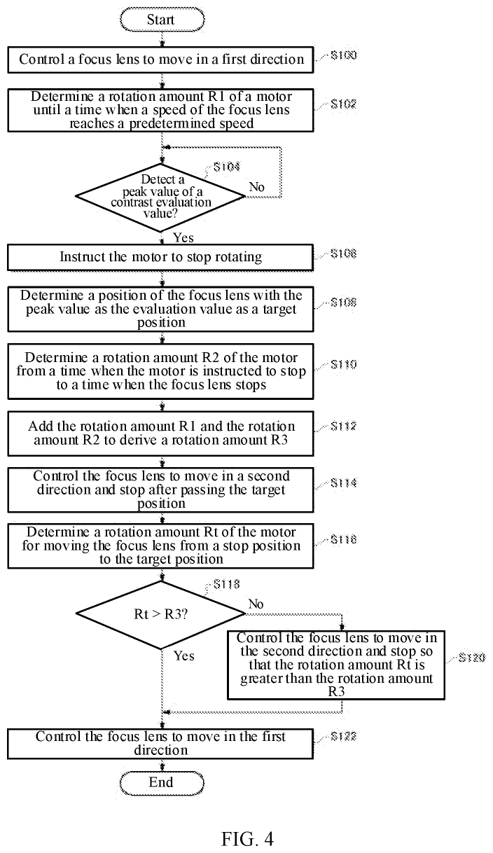

FIG. 4 is a flowchart of a process of performing a contrast detection AF according to an embodiment of the disclosure.

In order to perform the contrast detection AF, the focusing controller 116 instructs the lens controller 220 to drive the motor 216 to control the focus lens 210 to move in a first direction (S100). The focusing controller 116 controls the motor 216 so that a speed of the focus lens 210 reaches a predetermined speed. The determination circuit 112 determines a rotation amount R1 of the motor 216 until a time when the speed of the focus lens 210 reaches the predetermined speed (S102).

After the speed of the focus lens 210 reaches the predetermined speed, the focusing controller 116 further continues causing the focus lens 210 to move so that a peak value of the contrast evaluation value is detected (S104). When the focusing controller 116 detects the peak value of the contrast evaluation value, the focusing controller 116 instructs the motor 216 to stop rotating (S106).

The focusing controller 116 determines a position of the focus lens 210 with the peak value as the evaluation value as a target position (S108). The determination circuit 112 determines a rotation amount R2 of the motor 216 from a time when the motor 216 is instructed to stop to a time when the focus lens 210 stops (S110). The focusing controller 116 adds the rotation amount R1 and the rotation amount R2 to derive a rotation amount R3 (S112). The focusing controller 116 controls the focus lens 210 to move in a second direction by causing the motor 216 to rotate in a second rotation direction, and controls the focus lens 210 to stop after passing the target position (S114).

The focusing controller 116 determines a rotation amount Rt of the motor 216 for moving the focus lens 210 from a stop position to the target position (S116). The focusing controller 116 determines whether the rotation amount Rt is greater than the rotation amount R3 (S118). If the rotation amount Rt is not greater than the rotation amount R3, the focusing controller 116 further controls the focus lens 210 to move in the second direction and stop so that the rotation amount Rt is greater than the rotation amount R3 (S120).

When the rotation amount Rt is greater than the rotation amount R3, in order to control the focus lens 210 to move in the first direction again, the focusing controller 116 controls the motor 216 to rotate in the first rotation direction. After the speed of the focus lens 210 reaches the predetermined speed and when the rotation amount of the motor 216 until a time when the focus lens 210 reaches the target position reaches the remaining rotation amount R2, the focusing controller 116 instructs the lens controller 220 to stop the rotation of the motor 216 in the first rotation direction. Then, the focus lens 210 stops at the target position due to the friction force (S122).

As described above, for the photographing device 100 consistent with the disclosure, even if the rotation amount R1 and the rotation amount R2 change because of a change in the attitude of the lens unit 200, or the surrounding environment in which the photographing device 100 exists, the focus lens 210 can be accurately stopped at the target position in a short time.

However, when the attitude of the lens unit 200 is different, the friction force of the focus lens 210 is different due to the rotation direction of the motor 216. Therefore, in the above examples, the focus lens 210 is stopped at the target position by rotating the motor 216 in the same direction when the rotation amount R1 and the rotation amount R2 are determined. Therefore, after detecting the peak value of the contrast evaluation value, the focusing controller 116 controls the motor 216 to rotate in a reverse direction to temporarily return the focus lens 210 to a position passing the target position.

However, when the attitude of the lens unit 200 is an attitude in which the focus lens 210 can move in a horizontal direction, there are scenarios where the change in the friction force of the focus lens 210 due to the rotation direction of the motor 216 can be ignored. Further, the focusing controller 116 controls the motor 216 to rotate in the first rotation direction, controls the motor 216 to further rotate in the first rotation direction after detecting the peak value of the contrast evaluation value, and controls the focus lens 210 to stop when a distance greater than the distance H corresponding to the rotation amount R3 is reached. The rotation amount R3 is the sum of the rotation amount R1 and the rotation amount R2. Then, the motor 216 is controlled to rotate in the second rotation direction, and the focusing controller 116 instructs the lens controller 220 to stop the rotation of the motor 216 in the second rotation direction when the rotation amount of the motor 216 needed for the focus lens 210 to reach the target position reaches the remaining rotation amount R2.

The determination circuit 112 can determine whether the optical axis direction of the lens unit 200 is included in a predetermined direction range. The predetermined direction range may include the horizontal direction. If the optical axis direction of the lens unit 200 is not within the predetermined direction range, the focusing controller 116 controls the motor 216 to rotate in the second rotation direction opposite to the first rotation direction in which the motor 216 rotates when the peak value of the contrast evaluation value is detected. Further, the focusing controller 116 controls the focus lens 210 to move from the target position corresponding to the position of the focus lens 210 when the peak value of the contrast evaluation value is detected to a position with a distance to the target position of the focus lens 210 greater than the distance corresponding to the rotation amount R3. Then, the focusing controller 116 controls the motor 216 to start rotating in the first rotation direction, and in the state where the speed of the focus lens 210 is the predetermined speed, instructs the motor 216 to stop rotating in the first rotation direction when the rotation amount of the motor 216 needed for the focus lens 210 to reach the target position reaches the remaining rotation amount R2.

If the optical axis direction of the lens unit 200 is within the predetermined direction range, the focusing controller 116 further controls the motor 216 to rotate in the first rotation direction in which the motor 216 rotates when the peak value of the contrast evaluation value is detected. Further, the focusing controller 116 controls the focus lens 210 to move from the target position corresponding to the position of the focus lens 210 when the peak value of the contrast evaluation value is detected to a position with a distance to the target position of the focus lens 210 greater than the distance corresponding to the rotation amount R3. Then, the focusing controller 116 controls the motor 216 to start rotating in the second rotation direction, and in the state where the speed of the focus lens 210 is the predetermined speed, instructs the motor 216 to stop rotating in the second rotation direction when the rotation amount of the motor 216 needed for the focus lens 210 to reach the target position reaches the remaining rotation amount R2.

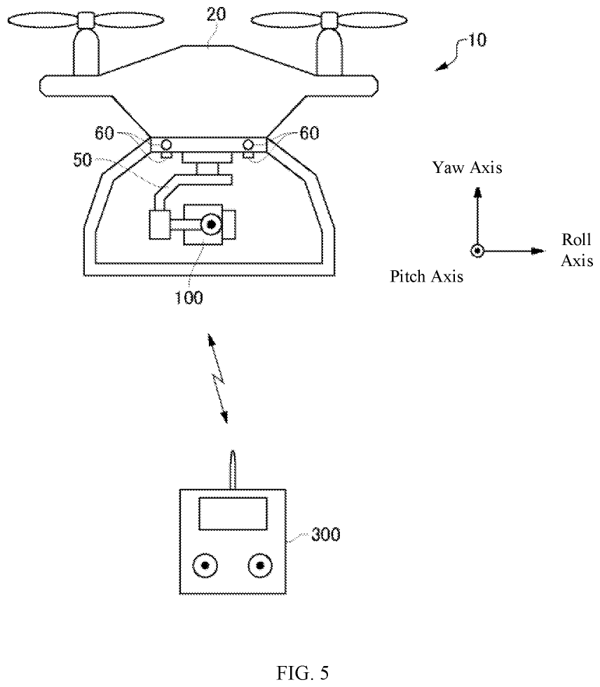

The photographing device 100 may be mounted at a movable body. The photographing device 100 may also be mounted at an unmanned aerial vehicle (UAV) as shown in FIG. 5. The UAV 10 includes a UAV body 20, a gimbal 50, a plurality of photographing devices 60, and the photographing device 100. The gimbal 50 and the photographing device 100 are an example of a photographing system. The UAV 10 is an example of the movable body propelled by a propulsion unit. In addition to the UAV, the movable objects also include other flight objects such as airplanes that move in the air, vehicles that move on the ground, and ships that move on the water.

The UAV body 20 includes a plurality of rotors. The plurality of rotors are an example of the propulsion unit. The UAV body 20 causes the UAV 10 to fly by controlling the rotation of the plurality of rotors. The UAV body 20 uses, for example, four rotors to enable the UAV 10 to fly. The number of rotors is not limited to four. Further, the UAV 10 may also be a fixed-wing aircraft without rotors.

The photographing device 100 may be an imaging camera that shoots an object included in a desired shooting range. The gimbal 50 rotatably supports the photographing device 100. The gimbal 50 is an example of a support mechanism. For example, the gimbal 50 may use an actuator to support the photographing device 100 rotatably around a pitch axis. The gimbal 50 may use actuators to further support the photographing device 100 rotatably around a roll axis and a yaw axis. The gimbal 50 can change an attitude of the photographing device 100 by rotating the photographing device 100 around at least one of the yaw axis, the pitch axis, or the roll axis.

The plurality of photographing devices 60 may be sensing cameras that shoot surroundings of the UAV 10 in order to control the flight of the UAV 10. The two photographing devices 60 may be provided at a nose, that is, the front of the UAV 10. Furthermore, the other two photographing devices 60 may be provided at a bottom surface of the UAV 10. The two photographing devices 60 on the front side may be paired to function as a stereo camera. The two photographing devices 60 on the bottom side may also be paired to function as a stereo camera. Three-dimensional spatial data around the UAV 10 can be generated from images shot by the plurality of photographing devices 60. Further, the number of photographing devices 60 included in the UAV 10 is not limited to four. The UAV 10 may include at least one photographing device 60. The UAV 10 may include at least one photographing device 60 at the nose, a tail, a side surface, a bottom surface, or a top surface of the UAV 10, respectively. An angle of view of the photographing device 60 may be greater than an angle of view of the photographing device 100. The photographing device 60 may have a single focus lens or a fisheye lens.

The remote operation device 300 communicates with the UAV 10 to remotely operate the UAV 10. The remote operation device 300 can wirelessly communicate with the UAV 10. The remote operation device 300 transmits to the UAV 10 instruction information indicating various instructions related to the movement of the UAV 10 such as ascending, descending, accelerating, decelerating, forward moving, backward moving, or rotating. The instruction information may include instruction information to raise a height of the UAV 10. The instruction information may show the height at which the UAV 10 should be located. The UAV 10 moves to the height indicated by the instruction information received from the remote operation device 300. The instruction information may include an ascending instruction to raise the UAV 10. The UAV 10 ascends while receiving the ascending instruction. When the height of the UAV 10 has reached an upper limit of the height, the UAV 10 can restrict the ascending even if the ascending instruction is received.

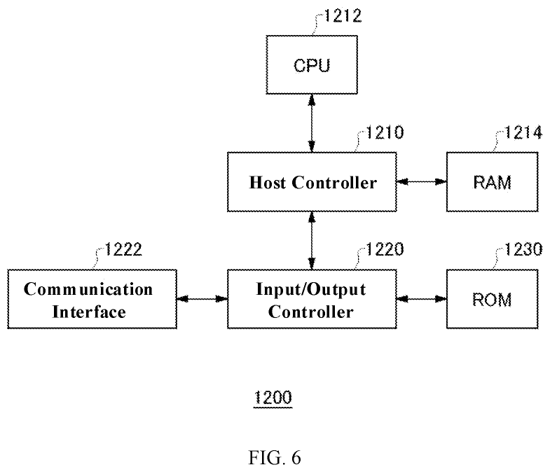

FIG. 6 shows an example of a computer 1200 that may embody one or more aspects of the present disclosure. The program installed on the computer 1200 can make the computer 1200 function as an operation associated with a device according to the embodiments of the present disclosure or one or more “units” of the device. In some embodiments, the program can cause the computer 1200 to perform the operation or the one or more “units.” The program enables the computer 1200 to execute a process or stages of the process consistent with embodiments of the present disclosure. The program can be executed by a CPU 1212 to make the computer 1200 execute specific operations associated with some or all of the blocks in the flowcharts or block diagrams described in this disclosure.

The computer 1200 of this disclosure includes the CPU 1212 and a RAM 1214, which are connected to each other through a host controller 1210. The computer 1200 further includes a communication interface 1222, an input/output unit, which is connected to the host controller 1210 through an input/output controller 1220. The computer 1200 also includes a ROM 1230. The CPU 1212 operates in accordance with programs stored in the ROM 1230 and RAM 1214 to control each unit.

The communication interface 1222 communicates with other electronic devices through a network. A hard disk drive can store programs and data used by the CPU 1212 of the computer 1200. The ROM 1230 stores a bootloader executed by the computer 1200 during operation, and/or a program dependent on the hardware of the computer 1200. The program is provided through a computer-readable medium such as a CR-ROM, a USB memory, or an IC card, or a network. The program is installed in the RAM 1214 or the ROM 1230, which are examples of computer-readable medium, and is executed by the CPU 1212. The information processing described in the programs is read by the computer 1200 and causes cooperation between the program and the various types of hardware resources described above. The device or method may be constituted by realizing the operation or processing of information with the use of the computer 1200.

For example, when a communication is performed between the computer 1200 and an external device, the CPU 1212 can execute a communication program loaded in the RAM 1214, and based on the processing described in the communication program, instruct the communication interface 1222 to perform communication processing. Under the control of the CPU 1212, the communication interface 1222 reads transmission data stored in a transmission buffer provided in a recording medium such as the RAM 1214 or a USB memory, and transmits the read transmission data to a network or writes received data received from the network in a receiving buffer provided in a recording medium.

Further, the CPU 1212 can make the RAM 1214 read all or required parts of files or databases stored in an external recording medium such as a USB memory, and perform various types of processing on the data of the RAM 1214. Then, the CPU 1212 can write the processed data back to the external recording medium.

Various types of information such as various types of programs, data, tables, and databases can be stored in the recording medium, and the information can be processed. For the data read from the RAM 1214, the CPU 1212 can execute various types of operations, information processing, conditional determination, conditional transfer, unconditional transfer, or information retrieval/replacement specified by the instruction sequence of the program described in the disclosure, and write the result back to the RAM 1214. In addition, the CPU 1212 can retrieve information in files, databases, or the like in the recording medium. For example, when a plurality of entries having attribute values of first attributes respectively associated with attribute values of second attributes are stored in the recording medium, the CPU 1212 may retrieve an entry that matches the condition that specifies the attribute value of the first attribute from the plurality of entries and read the attribute value of the second attribute stored in the entry to obtain the attribute value of the second attribute associated with the first attribute meeting a preset condition.

The programs or software modules described above may be stored at the computer 1200 or at a computer-readable storage medium near the computer 1200. In addition, a recording medium such as a hard disk or a RAM provided in a server system connected to a dedicated communication network or the internet can be used as a computer-readable storage medium to provide the program to the computer 1200 through the network.

The present disclosure has been described above using embodiments, but the technical scope of the present disclosure is not limited to the scope described in the above embodiments. It is obvious to those skilled in the art that various changes or improvements can be made to the above-described embodiments. All such changes or improvements can be included in the scope of the present disclosure.

The execution order of the actions, sequences, steps, and stages of the devices, systems, programs, and methods shown in the claims, specification, and drawings of the disclosure, can be implemented in any order as long as there is no special indication such as “before,” “in advance,” etc., and the output of the previous processing is not used in the subsequent processing. Regarding the operation procedures in the claims, the specification, and the drawings of the disclosure, the description is made using “first,” “next,” etc. for convenience, but it does not mean that the operations must be implemented in this order.

### REFERENCE NUMERALS

10—UAV 20—UAV Body 50—Gimbal 60—Photographing Device 100—Photographing Device 102—Photographing Unit 110—Imaging Controller 112—Determination Circuit 116—Focusing Controller 120—Image Sensor 130—Memory 160—Display 162—Instruction Circuit 200—Lens Unit 210—Focus Lens 211—Zoom Lens 212—Lens Driver 213—Lens Driver 214—Position Sensor 215—Position Sensor 216—Motor 217—Motor 220—Lens Controller 240—Memory 300—Remote Operation Device 1200—Computer 1210—Host Controller 1212—CPU 1214—RAM 1220—Input/Output Controller 1222—Communication Interface 1230—ROM

What is claimed is:

1. A control device comprising:
a processor; and
a storage device storing instructions that, when executed by the processor, cause the processor to:
determine a first rotation amount of a motor, configured to control a lens, from a time when the motor starts rotating to a time when a speed of the lens reaches a predetermined speed;
in response to the speed of the lens reaching the predetermined speed, determine a second rotation amount of the motor from a time when the motor is instructed to stop rotating to a time when the lens stops; and
in response to the lens moving to a reference position with a distance to a target position of the lens greater than a distance corresponding to a third rotation amount, control the motor so that the lens moves to the target position, the third rotation amount being a sum of the first rotation amount and the second rotation amount.

2. The control device of claim 1, wherein the instructions further cause the processor to:
in response to the lens moving to the reference position and stopping, control the motor to start rotating; and
in a state that the speed of the lens is the predetermined speed, instruct the motor to stop rotating in response to a rotation amount of the motor needed for the lens to reach the target position reaching the second rotation amount.

3. The control device of claim 1, wherein the instructions further cause the processor to:
determine the first rotation amount of the motor from the time when the motor starts rotating in a first rotation direction to the time when the speed of the lens reaches the predetermined speed;
in a state that the speed of the lens is the predetermined speed, determine the second rotation amount from the time when the motor is instructed to stop rotating in the first rotation direction to the time when the lens stops; and
in response to the lens moving to the reference position by rotating the motor in a second rotation direction opposite to the first rotation direction, control the motor to start rotating in the first rotation direction, and in a state that the speed of the lens is the predetermined speed, instruct the motor to stop rotating in the first rotation direction in response to a rotation amount of the motor needed for the lens to reach the target position reaching the second rotation amount.

4. The control device of claim 1, wherein:
a gear mechanism transmits power from the motor to the lens; and
the instructions further cause the processor to:
determine the first rotation amount including a predetermined rotation amount, the predetermined rotation amount being a rotation amount for a period in which the motor rotates but the lens does not move because of a gear backlash of the gear mechanism.

5. The control device of claim 1, wherein the instructions further cause the processor to:
in response to a contrast detection autofocus (AF) being started, determine the first rotation amount of the motor from the time when the motor starts rotating in a first rotation direction to the time when the speed of the lens reaches the predetermined speed;
in a state that the speed of the lens is the predetermined speed, determine the second rotation amount from the time when the motor is instructed to stop rotating in the first rotation direction according to a detection of a peak value of a contrast evaluation value to the time when the lens stops during a process of performing the contrast detection AF; and
after the lens stops in response to the detection of the peak value of the contrast evaluation value:
control the motor to rotate in a second rotation direction opposite to the first rotation direction, to cause the lens to move from the target position corresponding to a position of the lens when the peak value of the contrast evaluation value is detected to the reference position;
control the motor to start rotating in the first rotation direction; and
in a state that the speed of the lens is the predetermined speed, instruct the motor to stop rotating in the first rotation direction in response to a rotation amount of the motor needed for the lens to reach the target position reaching the second rotation amount.

6. The control device of claim 1, wherein the motor includes a direct-current (DC) motor, a coreless motor, or an ultrasonic motor.

7. A photographing device comprising:
the control device of claim 1; and
the lens.

8. A movable object comprising:
a photographing device including:
a lens;
a motor configured to drive the lens; and
a control device including:
a processor; and
a storage device storing instructions that, when executed by the processor, cause the processor to:
determine a first rotation amount of the motor from a time when the motor starts rotating to a time when a speed of the lens reaches a predetermined speed;
in response to the speed of the lens reaching the predetermined speed, determine a second rotation amount of the motor from a time when the motor is instructed to stop rotating to a time when the lens stops; and
in response to the lens moving to a reference position with a distance to a target position of the lens greater than a distance corresponding to a third rotation amount, control the motor so that the lens moves to the target position, the third rotation amount being a sum of the first rotation amount and the second rotation amount; and
a support mechanism supporting the photographing device and configured to change an attitude of the photographing device.

9. The movable object of claim 8, wherein the instructions further cause the processor to:
in response to the lens moving to the reference position and stopping, control the motor to start rotating; and
in a state that the speed of the lens is the predetermined speed, instruct the motor to stop rotating in response to a rotation amount of the motor needed for the lens to reach the target position reaching the second rotation amount.

10. The movable object of claim 8, wherein the instructions further cause the processor to:
determine the first rotation amount of the motor from the time when the motor starts rotating in a first rotation direction to the time when the speed of the lens reaches the predetermined speed;
in a state that the speed of the lens is the predetermined speed, determine the second rotation amount from the time when the motor is instructed to stop rotating in the first rotation direction to the time when the lens stops; and
in response to the lens moving to the reference position by rotating the motor in a second rotation direction opposite to the first rotation direction, control the motor to start rotating in the first rotation direction, and in a state that the speed of the lens is the predetermined speed, instruct the motor to stop rotating in the first rotation direction in response to a rotation amount of the motor needed for the lens to reach the target position reaching the second rotation amount.

11. The movable object of claim 8, wherein:
a gear mechanism transmits power from the motor to the lens; and
the instructions further cause the processor to:
determine the first rotation amount including a predetermined rotation amount, the predetermined rotation amount being a rotation amount for a period in which the motor rotates but the lens does not move because of a gear backlash of the gear mechanism.

12. The movable object of claim 8, wherein the instructions further cause the processor to:
in response to a contrast detection autofocus (AF) being started, determine the first rotation amount of the motor from the time when the motor starts rotating in a first rotation direction to the time when the speed of the lens reaches the predetermined speed;
in a state that the speed of the lens is the predetermined speed, determine the second rotation amount from the time when the motor is instructed to stop rotating in the first rotation direction according to a detection of a peak value of a contrast evaluation value to the time when the lens stops during a process of performing the contrast detection AF; and
after the lens stops in response to the detection of the peak value of the contrast evaluation value:
control the motor to rotate in a second rotation direction opposite to the first rotation direction, to cause the lens to move from the target position corresponding to a position of the lens when the peak value of the contrast evaluation value is detected to the reference position;
control the motor to start rotating in the first rotation direction; and
in a state that the speed of the lens is the predetermined speed, instruct the motor to stop rotating in the first rotation direction in response to a rotation amount of the motor needed for the lens to reach the target position reaching the second rotation amount.

13. The movable object of claim 8, wherein the motor includes a direct-current (DC) motor, a coreless motor, or an ultrasonic motor.

14. A control method comprising:
determining a first rotation amount of a motor, configured to control a lens, from a time when the motor starts rotating to a time when a speed of the lens reaches a predetermined speed;
in response to the speed of the lens reaching the predetermined speed, determining a second rotation amount of the motor from a time when the motor is instructed to stop rotating to a time when the lens stops; and
in response to the lens moving to a reference position with a distance to a target position of the lens greater than a distance corresponding to a third rotation amount, controlling the motor so that the lens moves to the target position, the third rotation amount being a sum of the first rotation amount and the second rotation amount.

15. The control method of claim 14, further comprising:
in response to the lens moving to the reference position and stopping, controlling the motor to start rotating; and
in a state that the speed of the lens is the predetermined speed, instructing the motor to stop rotating in response to a rotation amount of the motor needed for the lens to reach the target position reaching the second rotation amount.

16. The control method of claim 14, further comprising:
determining the first rotation amount of the motor from the time when the motor starts rotating in a first rotation direction to the time when the speed of the lens reaches the predetermined speed;
in a state that the speed of the lens is the predetermined speed, determining the second rotation amount from the time when the motor is instructed to stop rotating in the first rotation direction to the time when the lens stops; and
in response to the lens moving to the reference position by rotating the motor in a second rotation direction opposite to the first rotation direction, controlling the motor to start rotating in the first rotation direction, and in a state that the speed of the lens is the predetermined speed, instructing the motor to stop rotating in the first rotation direction in response to a rotation amount of the motor needed for the lens to reach the target position reaching the second rotation amount.

17. The control method of claim 14, wherein:
a gear mechanism transmits power from the motor to the lens; and
the control method further comprises:
determining the first rotation amount including a predetermined rotation amount, the predetermined rotation amount being a rotation amount for a period in which the motor rotates but the lens does not move because of a gear backlash of the gear mechanism.

18. The control method of claim 14, further comprising:
in response to a contrast detection autofocus (AF) being started, determining the first rotation amount of the motor from the time when the motor starts rotating in a first rotation direction to the time when the speed of the lens reaches the predetermined speed;
in a state that the speed of the lens is the predetermined speed, determining the second rotation amount from the time when the motor is instructed to stop rotating in the first rotation direction according to a detection of a peak value of a contrast evaluation value to the time when the lens stops during a process of performing the contrast detection AF; and
after the lens stops in response to the detection of the peak value of the contrast evaluation value:
controlling the motor to rotate in a second rotation direction opposite to the first rotation direction, to cause the lens to move from the target position corresponding to a position of the lens when the peak value of the contrast evaluation value is detected to the reference position;
controlling the motor to start rotating in the first rotation direction; and
in a state that the speed of the lens is the predetermined speed, instructing the motor to stop rotating in the first rotation direction in response to a rotation amount of the motor needed for the lens to reach the target position reaching the second rotation amount.

19. The control method of claim 14, wherein the motor includes a direct-current (DC) motor, a coreless motor, or an ultrasonic motor.

20. A non-transitory computer-readable storage medium storing a program that, when executed by a computer, causes the computer to perform the control method of claim 14.
